(19) United States
(12) Patent Application Publication
(10) Pub. No.: US 2014/0351012 A1
(43) Pub. Date: Nov. 27, 2014

(54) Methods and Systems for Managing Promotional Campaigns Based on Predicted Consumer Behavior

(71) Applicants: Charles Carter Jernigan, Santa Clara, CA (US); Seth Priebatsch, Boston, MA (US)

(72) Inventors: Charles Carter Jernigan, Santa Clara, CA (US); Seth Priebatsch, Boston, MA (US)

(21) Appl. No.: 13/901,344

(22) Filed: May 23, 2013

(51) Int. Cl. G06Q 30/02

(52) U.S. Cl. CPC G06Q 30/0202
USPC 705/7.31

(57) ABSTRACT

Systems and methods for running a promotional campaign in which publicly available information on social-media websites regarding member preferences and individuals with whom they socialize is computationally analyzed to drive selection of a cohort to whom a promotion will be directed by identifying individuals clustered into groups with shared preferences and habits directly associated with the subject matter of the promotional campaign.

### BACKGROUND

Merchants and suppliers often use promotional campaigns when marketing their products, providing consumers or business customers with discounts or other incentives to purchase goods or services. Promotional campaigns include coupons, price reductions, buy-one-get-one-free promotions, contests, and the like. The objective of a sales promotion is to induce consumers to try or purchase products. Ideally, these efforts are directed toward the most profitable prospects: “high-yield” consumers most like to buy, and to do so in quantity. For example, a merchant might not want to waste a promotional offer on someone likely to try the product once, if at all, and never repeat the purchase; rather, merchants target consumers who exhibit habitual behavior. Additionally, merchants try to target consumers who fit key demographic and/or psychographic criteria that imply predisposition toward their products. Demographics are basic characteristics such as sex, age, education and occupation, while psychographics indicate a person's preferences and intentions; psychographics are helpful in targeting consumers of products such as cigarettes, beer and cosmetics that do not correlate well with demographic characteristics.

Unfortunately, current methods of targeting promotions, which tend to rely on broad group characteristics, are limited in effectiveness. For example, a seller may target women of age 25 to 45 for a new cosmetic product by placing a promotional offer, such as a coupon, in a women's magazine. Ultimately, however, the seller may find the demographic to have been substantially over inclusive, reaching many women, and even men, who are unlikely to become repeat customers. Of course, if sellers are restricted to marketing channels (such as media advertisements) that are coarse and unfocused, then coarse targeting criteria are harmless; since individuals cannot be specifically targeted, analytics at the individual level cannot be exploited.

These marketing limitations are changing rapidly. The widespread adoption of mobile communication devices allows sellers to target their owners individually, and in large numbers, for promotional purposes. A seller's ability to direct promotions to individual mobile phones and tablets, based on criteria specific to their owners, renders traditional group-level marketing and group-level analytics obsolete. In particular, if sellers could efficiently and reliably estimate the value of a prospect on an individual level, promotional campaigns could be more effectively targeted; fewer communications would be wasted and fewer promotions would be redeemed by those unlikely to become repeat purchasers.

### SUMMARY

The present invention utilizes the increasing popularity of “social networking” websites, which allow individuals to cluster into groups based on shared preferences and habits rather than broad (and often meaningless) demographic similarities, to drive selection of a cohort of individuals to whom a promotion will be directed—e.g., via mobile communication devices. Social networking sites contain large amounts of information regarding member preferences and individuals with whom they socialize or are otherwise identifiably connected. Searching for individuals who have posted certain key terms, or have joined groups associated directly with the subject matter of a promotional campaign, allows the campaign organizer to identify an initial cohort of prospects. Computationally analyzing the social connections of this cohort based on information publicly available on social-media websites facilitates expansion of the initial cohort in a manner that retains prospect value. In some embodiments, records of the actual consumer behavior of targeted individuals facilitates refinement of the targeting criteria. For example, the campaign organizer may track who within the targeted cohort viewed the promotion; which of those viewers redeemed the promotion; and which of those individuals exhibited repeat purchase behavior. These downstream behaviors can be tracked so long as, for example, data is shared between the campaign organizer and the actual seller(s). To protect consumer privacy, targeting information may be maintained securely, anonymously and/or based on relevant consumer characteristics rather than consumer identities.

Accordingly, in one aspect, the invention pertains to a computer-implemented method of conducting a marketing campaign to identify consumers for a promotional offer for goods or services offered by a merchant. In representative embodiments, the method includes identifying at least one seed prospect likely to redeem the promotional offer and subsequently purchase goods or services from the merchant; obtaining information regarding social connections of the at least one seed prospect; identifying, based on computational analysis of the social-connection information, additional prospects also likely to redeem the promotional offer and subsequently purchase goods or services from the merchant; and transmitting the promotional offer to one or more of the seed prospect and the additional prospects. The information regarding social connections may be obtained from at least one social media website. In various embodiments, screening the additional prospects may be based on information obtained via the social media website and relevant to a receptivity to the promotional offer; the promotional offer may be transmitted only to the screened prospects. Alternatively or additionally, the screening may be based in part on a strength of the social connection information among prospects. The strength may be based at least in part on a number of interactions between prospects and/or a type of interaction between prospects, and the screening may be based at least in part on the strength of at least one connection between an additional prospect and a screened prospect.

In various embodiments, the method further comprises tracking purchasing behavior of prospects who have redeemed the promotional offer to determine a success criterion associated with each such prospect; the screening may be based at least in part on the success criteria. Alternatively or additionally, screening the additional prospects may be based on past purchasing behavior from the merchant, past purchasing behavior at locations geographically proximate to the merchant, and/or past purchasing behavior of goods or services related to the goods or services that are the subject of the promotional offer.

In another aspect, the invention relates to a system for conducting a marketing campaign to identify consumers for a promotional offer for goods or services offered by a merchant. In various embodiments, the system includes a prospect database for storing information regarding a plurality of consumers, and a processor for executing (i) a first identification module for identifying, from among the consumers in the prospect database, a seed prospect likely to redeem the promotional offer and subsequently purchase goods or services from the merchant; (ii) a query module for obtaining, from at least one social media website, information regarding social connections of the at least one seed prospect; (iii) a second identification module for identifying, based on computational analysis of the social-connection information, additional prospects also likely to redeem the promotional offer and subsequently purchase goods or services from the merchant; and (iv) a distribution module for transmitting the promotional offer to the seed prospect and the additional prospects. The system may include a screening module for screening the additional prospects based on information obtained by the query module and relevant to a receptivity to the promotional offer, the distribution module being responsive to the screening module and configured to transmit the promotional offer only to the screened prospects. Alternatively or additionally, the screening module may be configured to screen based in part on a strength of the social connection information among prospects. The strength may be based at least in part on a number of interactions between prospects and/or a type of interaction between prospects, and the screening may be based at least in part on the strength of at least one connection between an additional prospect and a screened prospect.

In various embodiments, the system also includes a tracking module for tracking purchasing behavior of prospects who have redeemed the promotional offer to determine a success criterion associated with each such prospect, the screening being based at least in part on the success criteria. The prospect database may store past purchasing behavior of prospects from the merchant and/or past purchasing behavior of prospects from locations geographically proximate to the merchant, the screening module being configured to screen the additional prospects based thereon. In addition or alternatively, the prospect database may store past purchasing behavior of prospects based on types of goods and services, and the screening module may be configured to screen the additional prospects based on past purchasing behavior of goods or services related to the goods or services that are the subject of the promotional offer.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. In addition, the terms like “consumer equipment,” “mobile station,” “mobile,” “communication device,” “access terminal,” “terminal,” “handset,” and similar terminology, refer to a wireless device (e.g., cellular phone, smart phone, computer, PDA, set-top box, Internet Protocol Television (IPTV), electronic gaming device, printer, and so forth) utilized by a consumer of a wireless communication service to receive or convey data, control, voice, video, sound, gaming, or substantially any data-stream or signaling-stream. The foregoing terms are utilized interchangeably in the subject specification and related drawings. The terms “component,” “system,” “platform,” “module,” and the like refer broadly to a computer-related entity or an entity related to an operational machine with one or more specific functionalities. Such entities can be hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 is a block diagram of an exemplary network in accordance with an embodiment of the invention;

FIG. 2 is a block diagram of an exemplary campaign processor in accordance with an embodiment of the invention;

FIG. 3 conceptually illustrates the principles of construction of a social graph in accordance with an embodiment of the invention;

FIG. 4 depicts a method for identifying a cohort of consumers to whom a promotional offer will be directed in accordance with an embodiment of the invention; and

FIGS. 5A, 5B, 5C, and 5D are flowcharts illustrating identification of a cohort of consumers to whom a promotional offer will be directed in accordance with an embodiment of the invention.

### DETAILED DESCRIPTION

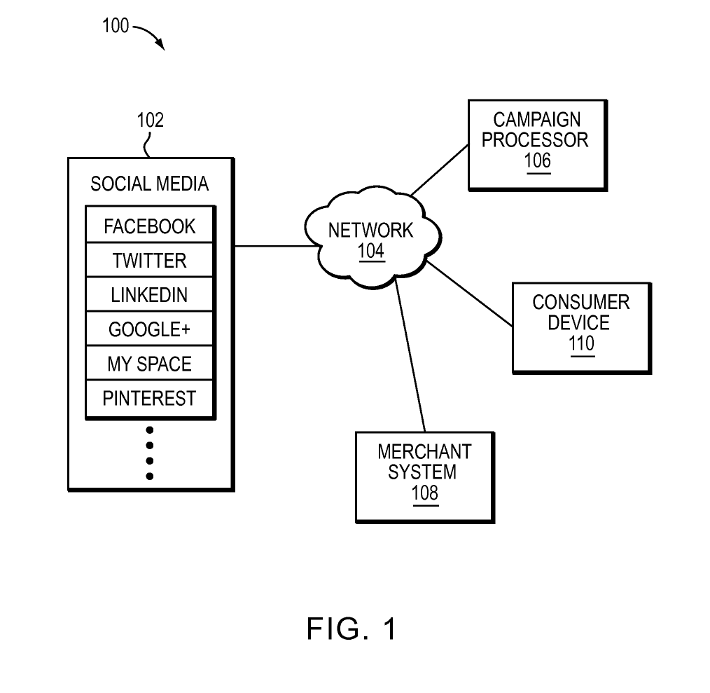

Refer first to FIG. 1, which depicts an exemplary promotional-campaign network 100 including one or more social media applications 102 linked to other systems via a network 104 that supports wired, wireless, or any two-way communication (e.g., a cellular telephone network, the Internet, or any wide-area network or combination of networks capable of supporting point-to-point data transfer and communication). The social-media application(s) 102 may be a collaborative project (e.g., WIKIPEDIA), blog or microblog (e.g., TWITTER and PINTEREST), content community (e.g., YOUTUBE and DAILYMOTION), social networking site (e.g., FACEBOOK and GOOGLE+), virtual game world (e.g., WORLD OF WARCRAFT), virtual social world (e.g. SECOND LIFE), or any one, or combination of, network-based applications that allows the creation and/or exchange of user-generated content. The network 104 also connects various devices, including a campaign processor 106, one or more merchant systems 108, and a consumer device (e.g., a mobile device) 110 utilizing, again, wired, wireless, or any suitable form of two-way communication. The campaign processor 106 operates as described in greater detail below, and may be implemented as a running process on a stand-alone computer or can be integrated, in some embodiments, with a merchant system 108. Each merchant system 108 may be associated with a merchant that offers goods or services for sale and wishes to use a promotional campaign to market its products. The merchant system 108 may include at least one central computing system with one or more point-of-sale (POS) devices physically or electronically linked to it.

In response to a request to begin a new promotional campaign, the campaign processor 106 analyzes data accumulated from previous campaigns, transactional data from merchant system 108, and social networking event data of prospective consumers from the social network 104 to identify a cohort of consumers to whom the promotion will be directed. The campaign processor 106 transmits the promotional offer to the mobile device 110 associated with each consumer having an account with the campaign processor 106 and/or to the social media account of the consumer identified in the cohort. As used herein, the term “mobile device” used for receiving and claiming promotional offers by the consumer refers to a “smart phone” or tablet with advanced computing ability that, generally, facilitates bi-directional communication and data transfer using a mobile telecommunication network, and is capable of executing locally stored applications and/or payment transactions. Mobile devices include, for example, IPHONES (available from Apple Inc., Cupertino, Calif.), BLACKBERRY devices (available from Research in Motion, Waterloo, Ontario, Canada), or any smart phones equipped with the ANDROID platform (available from Google Inc., Mountain View, Calif.), tablets, such as the IPAD and KINDLE FIRE, and personal digital assistants (PDAs).

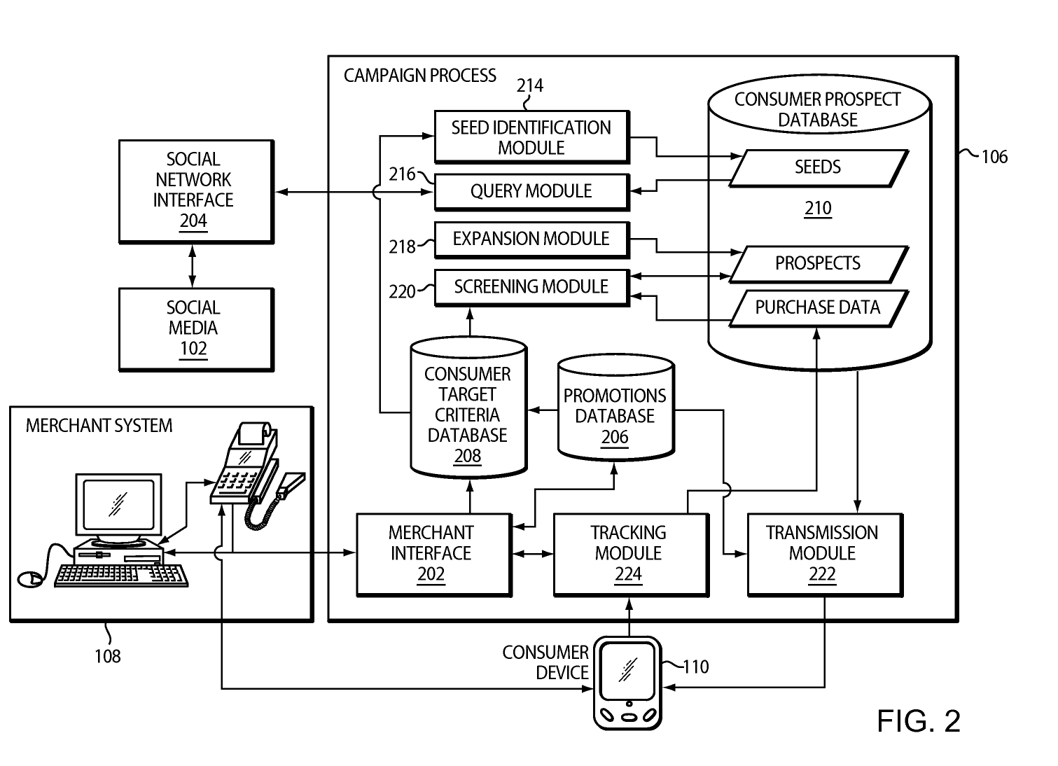

FIG. 2 shows in greater detail the functional components of the campaign processor 106 including, in various embodiments, a merchant interface 202 configured to receive promotional campaign specifications and updates from the merchant or merchant system 108. In the illustrated embodiment, the campaign processor 106 interacts with a social network interface 204 in order to retrieve relevant social media data about prospective consumers from the social media applications 102. The social network interface 204 may be one of a variety of public APIs provided by social media applications for the use of third-party applications to collect data available from the social media application 102. The merchant interface 202 may be any form of application programming interface (API), such as a website, enabling communication via network 104 between the merchant system 108 and the campaign processor 106—in particular, allowing a merchant to log in and define a new promotional campaign and relevant search criteria for a target consumer cohort. It should be noted that data reflecting an individual's social connections may be obtained, alternatively or in addition, from email, text messages, online chats, phone call records, etc.

Records of all active and completed promotional campaigns are stored in a promotions database 206 and records of the target consumer criteria are saved in a consumer target criteria database 208; in the latter case, the records include an identifier of the promotion for which they are defined. Both databases 206, 208 are typically implemented on one or more mass-storage devices accessible (either locally or remotely) to the merchant interface 202 and to various operating modules of the campaign processor 106. Additionally, information about prospective consumers and their transactions with a merchant, such as promotional offers redeemed and items purchased, may be transmitted through the merchant interface 202 and saved in a prospect database 210. The prospect database 210 stores, for example, a record of each prospective consumer having an account with, or having done business with (e.g., purchased good or services or claimed past promotions) the campaign processor 106 and/or any associated merchant. During the process of searching for suitable prospects for a promotional offer, as described below, data collected may be saved to the prospect database 210 for analysis in subsequent promotional campaigns. The records may contain associated events, social connections, and transactional data collected and updated during past campaigns as well as from associated merchants. More specifically, the records may contain, for each consumer, one or more of transaction patterns at a single merchant, transaction patterns across merchants, categories of items purchased, type of registered mobile device, category of promotions claimed and/or redeemed in the past, merchant feedback about the consumer, and consumer ratings of the merchant. The prospect database 210 may be physically housed within the campaign processor 106 or it may be connected remotely though network 104.

The machine running the campaign processor 106 has memory containing instructions, conceptually illustrated as a group of modules that control the operation of the processor and its interaction with hardware components. The memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. An operating system directs the execution of low-level, basic system function such as memory allocation, file management operation of the mass storage devices. At a higher level, a seed identification module 214, a social media query module 216, an expansion module 218, a screening module 220, a transmission module 222, and a tracking module 224 may perform the critical functions associated with embodiments of the present invention.

In operation, a merchant accesses the system 106 by logging into the merchant interface 202, which typically requires conventional authentication and sign-in. Although the campaign-processor system 106 may be integrated with the merchant system 108 or otherwise operated entirely by the merchant, as noted above, in typical implementations the system 106 is implemented at a server accessible to multiple merchants via, for example, the Internet; in such implementations, the server maintains separate logical or physical databases 206, 208 for each participating merchant and, via web interaction with the server and pages personalized to the merchant, the merchant experiences use of the system 106 as if implemented on a merchant-controlled computer. Upon logging in, the merchant is prompted to choose from a menu of options including pre-defined offers (e.g., a discount applied to a total sale amount) saved as templates in the promotions database 206. Alternatively, the merchant may wish to define a new offer (e.g., a discount on a specific item); the merchant interface 202 guides the merchant through the steps of defining the offer, the terms of which are then saved to the promotions database 206. After the promotional offer has been defined, the merchant is prompted to enter target consumer criteria for the promotion to define the demographic(s) and psychographic(s) of the target population. These criteria are saved to the consumer target criteria database 208 in a record associated with the promotional campaign for which they are defined. In some embodiments, the consumer target criteria database may also contain universal criteria used for all campaigns (such as data indicative of habitual behavior indicating brand loyalty) that may generically favor (or disfavor) a consumer as a cohort member. The merchant may, however, select to ignore some or all of these criteria when searching for prospects.

Once the target consumer criteria have been defined, the seed identification module 214 queries the consumer records stored in the prospect database 210 for records consistent with the merchant-defined criteria; the module 214 identifies prospects found to meet criteria as seed prospects, which are used to find additional prospects with shared preferences and habits relevant to the current campaign. Each record in the database 210 is reviewed in this manner, and upon completion of the review the social media query module 216 collects, via the social network interface 204, social media activity, from the social media application(s) 102, for each seed prospect. The collected data is analyzed by the expansion module 218, which is configured to construct a social graph (explained in further detail below) for each seed prospect; based on this graph, social connections of each seed prospects are identified and evaluated as potential prospects to populate the prospect database 210. The screening module 220 analyzes the potential prospects to identify cohort members based at least in part on shared preferences, habits, and social interactions indicating the strength of connections; the transmission module 222 transmits the promotional offer to the members of the cohort—e.g., to their mobile devices. Alternatively or in addition, the offer may be transmitted to a social media or email account of a cohort member. Following transmission of the promotional offer, the tracking module 224 may track the status of each offer and update the records in the prospect database 210, entering data indicative of claiming the promotion, redeeming the promotion, the elapsed times between the prospect's receipt, claiming and redemption of the offer, the mode of transmission, etc. For example, this tracking data may be obtained directly from any mobile device 110 configured to transmit data to the campaign processor 106, by querying the social media application 102 once the consumer has claimed the offer, and/or from the merchant system 108 when the consumer has redeemed the offer.

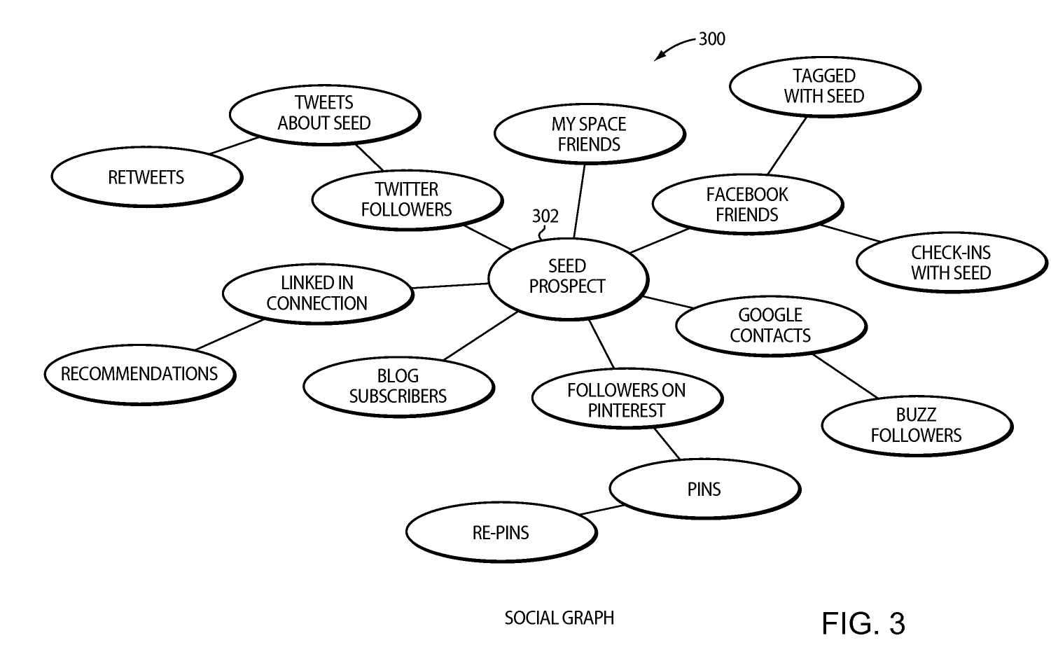

FIG. 3 illustrates the principles of constructing a representative social graph 300. One individual, a seed candidate 302, may have an account with one or more social media application 102 and within each application the seed candidate 302 may have multiple, if not hundreds, of social links. These social links may be “friends” or other connections established by the seed candidate 302. Social links may also be determined from the seed candidate's interactions with other users. In this way, the social graph 300 may be constructed by the expansion module 218 from data obtained by the query module 216 via the social network interface 204. In some embodiments, the strength of the social links is assessed by analyzing the frequency and/or nature of the interactions between users. For example, depending on the desired cohort size and the number of social links associated with the seed prospects 312, the merchant may set a strength threshold below which social links do not qualify for the cohort of prospects who will receive the offer. For example, a call to a family member means that calls might be a particular consumer's preferred method of communicating with people with whom she is close, thus diminishing the significance of, e.g., interactions via texting. The strength may be assigned a numeric value (e.g., a count of interactions) and any prospects with strength of connection value below a defined threshold will not be identified to receive the offer.

The collected data—i.e., the entire social graph—is typically downloaded into a database partition for analysis and pruning based on, e.g., strength considerations in order to identify, from the social graph, suitable prospects for the promotional offer. Records that survive this process may have relevance for other promotional campaigns and may therefore be saved to the prospect database 210, and utilized as described below. To the extent that identification of an individual via the social network interface 204 does not yield sufficient information to permit an offer to be transmitted to that individual, and that individual's record survives the pruning process, the query module 216 may search other social media and/or other sites to develop further contact information.

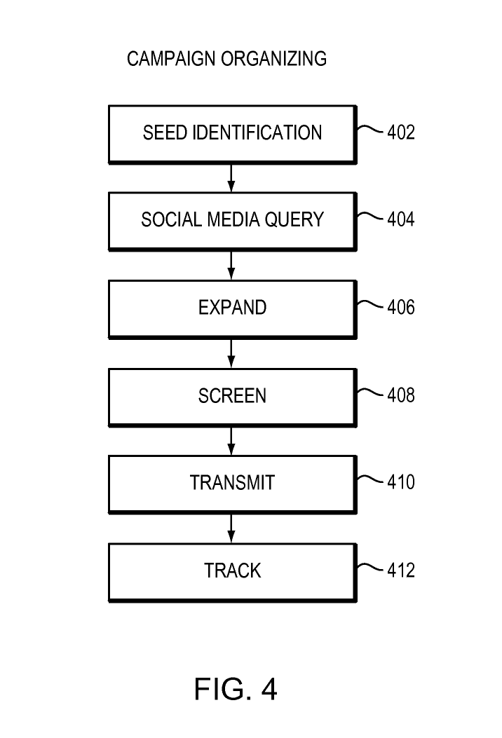

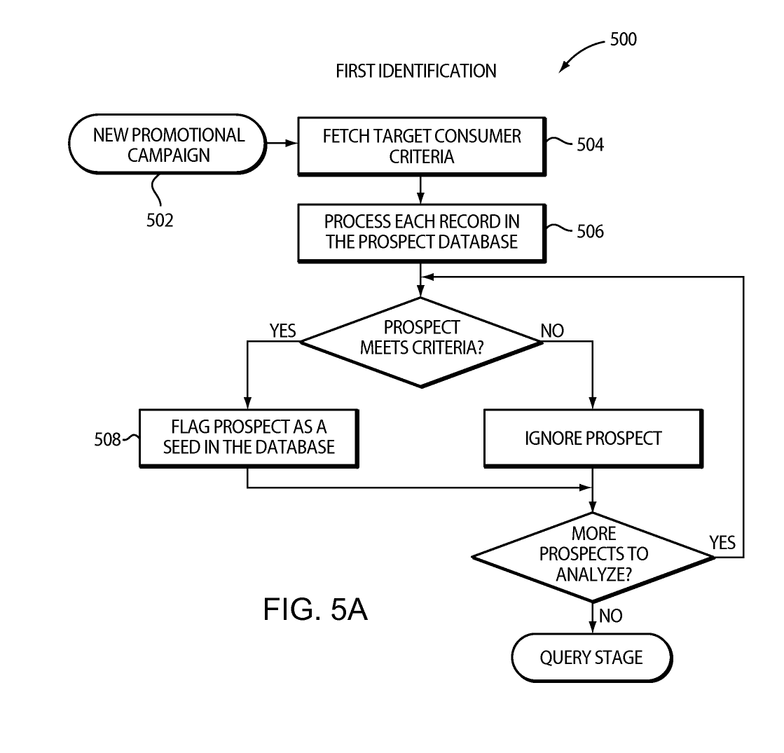

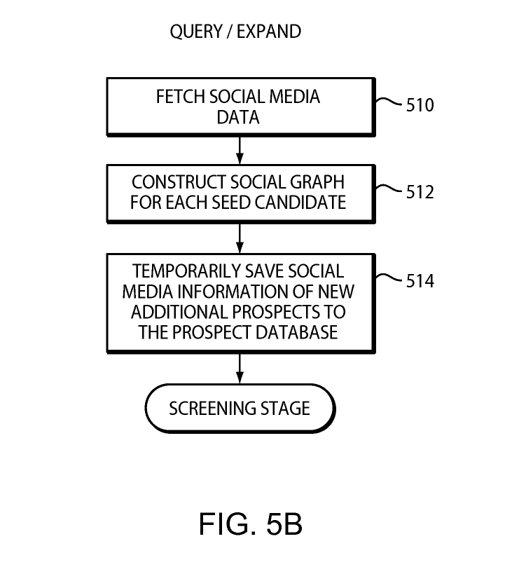

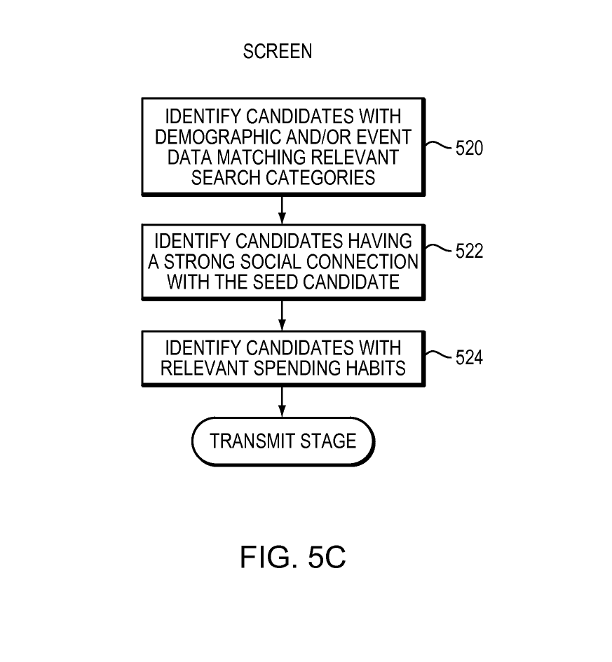

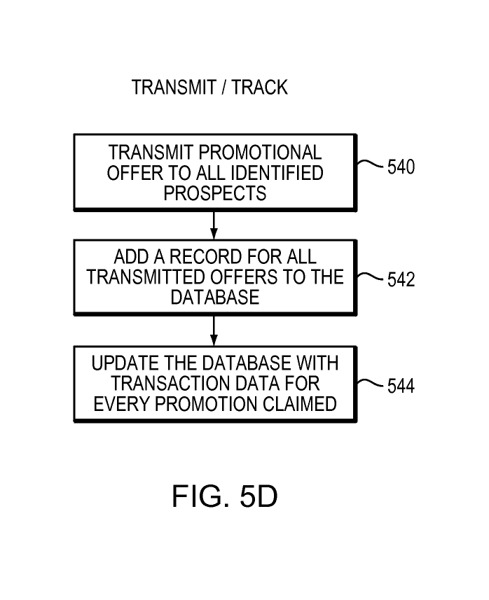

As illustrated in FIG. 4, promotional campaigns in accordance herewith may involve different stages: a seed identification stage 402, a social media query stage 404, an expansion stage 406, a screening stage 408, a transmission stage 410, and a tracking stage 412. The various stages may be understood in connection with the representative method 500, illustrated in FIGS. 5A-5D, for effectively organizing a promotional campaign to identify target consumer cohorts in accordance with embodiments of the current invention. With reference to FIGS. 1 through 5D, assuming the merchant has an account with the campaign processor 106, the merchant logs into the merchant interface 202 on any system or device with access to network 104 to start a new promotional campaign. The merchant may choose from existing promotional offers—i.e., offer templates or previously defined offers, which may be re-used and modified as appropriate—or may define his own offer (step 502). Upon successful log-in, the merchant is prompted to choose or define parameters of the campaign, such as the type of promotion (e.g., discount amount, buy one get one free offer, etc.), the time period to run the campaign, relevant search categories (e.g., camping or hiking), and key search words and phrases (e.g., hiking trails, mountains, tents, or sleeping bags) that can be used for screening purposes as described below. These parameters are saved to the consumer target criteria database 208. In some embodiments, general characteristics of a good prospect, such as manifestations of brand loyalty, may already be saved in the consumer target criteria database 208. The goal is to define target criteria that will identify consumers displaying habitual purchasing behavior and an interest in categories similar to the goods or services that are the subject of the promotion. For example, a merchant offering a promotion on tents may circulate the promotion to consumers with past purchasing behavior in the general category of camping supplies.

In the seed identification stage 402, the seed identification module 214 retrieves the search criteria from the consumer target criteria database 208 (step 504) and queries the prospect database 210 for records containing behavior patterns, demographic data and/or events matching or relevant to the defined criteria (step 506); for example, a high degree of matching may be registered if, in the case of the tent promotion mentioned above, prospects are identified who have recently acted on offers relating to camping equipment. An advantage of the invention is that the consumer prospect database 210 need not be limited to customers of the particular merchant (although such customers may be accorded a higher weight for search purposes); instead, in the case of a system 106 implemented to serve many merchants, the database 210 may include prospects developed in connection with all or a subset of merchants. The degree of matching necessary for a seed prospect to be flagged may be context-specific and/or adjustable. For example, the size of the seed pool may depend on the target size of the cohort; if a target degree of matching fails to identify an adequate number of seed candidates, the degree of matching may be relaxed until the seed quota is filled.

Prospect records are flagged as they are identified as meeting the matching criteria (step 508). The information used as the basis for match detection may include transaction patterns at a single merchant, transaction patterns across a variety of merchants, past purchasing behavior (e.g., at locations geographically proximate to the merchant), categories of items purchased, category of campaigns claimed and/or redeemed in the past, merchant feedback about the consumer, consumer ratings of a merchant, and/or social media events and connections. For example, a prospect posting photos from a camping trip, joining a hiking group, “liking” sites relevant to camping, having a history of buying camping supplies, doing business with merchants specializing in camping supplies, etc., may be flagged. This prospect is defined as a seed candidate 302 to be used to find additional prospects with similar interests and behavior, by looking at other people within the seed candidate's social network.

To identify these additional prospects, the seed candidates' social media information is obtained by the social media query module 216 via the social media interface 204 (step 510) and used to map connections to construct the social graph 300 (step 512) to identify additional prospects. In the expansion stage 406, the identified additional prospects are cross-referenced with records in the prospect database 210 to determine whether any of these prospects already have an existing record in the database 210; if so, that record is flagged for subsequent screening by the screening module 222. Social media information (such as event data) is obtained by the query module 216 for the additional prospects who do not have an existing record and this information is temporarily saved for further analysis (step 514). Data obtained for each additional prospect is screened (step 408) for demographic data and/or events matching the identified relevant search categories and/or key words and phrases (step 520). Individuals whose records survived the expansion pruning process or whose records in the prospect database 210 have been flagged will receive the current promotional offer via a preferred modality (e.g., mobile phone) or by the best modality that can be gleaned from the information retrieved by the query module 216.

In some embodiments, tracing this social media activity can lead to additional behavioral insights that may be analyzed at this point. For example, the connections between people are not uniformly reciprocal; the information flowing along the link between people is typically not even or balanced—i.e., some people are “followers” while some are “followed.” Ideally, the merchant wants to attract the “followed” consumers who will influence others to buy goods or services that they recommend. Accordingly, in some embodiments, criteria on which expansion is based may include analysis of data (such as the asymmetry of data flows along the social links) bearing on the degree to which an additional prospect is “followed.” Alternatively, or in addition, the strength of the social connections is a criterion on which additional prospects are evaluated, and strength may be determined by analyzing the frequency of interactions extracted from the social graph between the prospects and the seed candidate 302 over a set period of time (step 522). In addition to interactions via social media, interactions via a registered consumer's mobile device 110 may also be considered. For example, a call to a family member means that calls might be a particular consumer's preferred method of communicating with people with whom she is close, thus diminishing the significance of, e.g., interactions via social media or texting. The strength may be assigned a numeric value (e.g., a count of interactions) and any prospects with strength of connection value below a defined threshold will not be identified to receive the offer.

Additionally, the merchant may wish to target consumers with specific spending habits. For example, the merchant may wish to target only new consumers, existing consumers who have not completed a transaction within a certain amount of time, consumers who spend above a certain amount, or even consumers that have purchased a specific item in the past. A newly identified additional prospect's transaction data with the merchant may be queried and uploaded from the merchant system 108 to the prospect database 210 (via the merchant interface 202) for analysis by the screening module 220; each temporary record of a newly identified prospect and each flagged record of an existing prospect is analyzed and the record of any prospect not passing the defined spending habit criteria is deleted or un-flagged (step 524). Negative criteria may be defined to “weed out” or downwardly weight additional prospects who have claimed a promotional offer in the past but did not spend additional money or become repeat customers with the merchant offering the promotion; that is, additional prospects, once identified through the social graph 300, may already exist in the consumer prospect database 210 and/or in the merchant's customer database, and analysis of this existing data is employed to determine whether to add additional prospects to the cohort.

At this time all identified prospects, including those flagged as seed candidates, are transmitted a promotional offer by the transmission module 222 (step 540) and their records are updated to indicate the promotion offered (step 542). In some embodiments, the offer is transmitted to the mobile device 110 associated with the account of each prospect. Alternatively, the offer may be transmitted to a social media or email account of the identified prospect. Following offer transmission, the tracking module 224 tracks the status of each offer and updates the records in the prospect database 210 accordingly (step 544). In some embodiments, this tracking data may be obtained directly from mobile device 110 (which may execute a local application (“app”) causing it to transmit data to the campaign processor 106). Alternatively or in addition, the status of an offer transmitted to a social media account may be retrieved via the social media interface 204 and/or information about offers redeemed with a merchant may be retrieved from the merchant via the merchant interface 202. In some embodiments, consumers having an account with the campaign processor 106 may allow additional permissions for data mining of their mobile device 110. Additional data, such as location and interactions with social connections via mobile device, may be obtained through the tracking module 224 updating a consumer's record in the prospect database 210 accordingly.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. For example, each of the processors described herein may be a general-purpose computer, but alternatively may be a CSIC (customer-specific integrated circuit), ASIC (application-specific integrated circuit), a logic circuit, a digital signal processor, a programmable logic device, such as an FPGA (field-programmable gate array), PLD (programmable logic device), PLA (programmable logic array), RFID processor, smart chip, or any other device or arrangement of devices that is capable of implementing the steps of the processes of the invention.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The various modules and apps described herein can include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A computer-implemented method of conducting a marketing campaign to identify consumers for a promotional offer for goods or services offered by a merchant, the method comprising:
identifying, with a computer, at least one seed prospect likely to redeem the promotional offer and subsequently purchase goods or services from the merchant;
obtaining, by the computer via a computer network, information regarding social connections of the at least one seed prospect;
identifying, based on computational analysis of the social-connection information, additional prospects also likely to redeem the promotional offer and subsequently purchase goods or services from the merchant;
according a weight, by a computer, to at least some of the additional prospects based on at least one of (i) a history of their past purchases or (ii) their past purchases in response to promotional campaigns;
screening, by a computer, the additional prospects based at least in part on the weights; and
transmitting the promotional offer to one or more of the seed prospect and the screened additional prospects.

2. The method of claim 1, wherein the information regarding social connections is obtained from at least one social media website.

3. The method of claim 2, further comprising further screening the additional prospects based on information obtained via the social media website and relevant to a receptivity to the promotional offer, and transmitting the promotional offer only to the further screened prospects.

4. The method of claim 3, wherein the further screening is based in part on a strength of the social connection information among prospects.

5. The method of 4, wherein:
the strength is based at least in part on a number of interactions between prospects; and
the further screening is based at least in part on the strength of at least one connection between an additional prospect and a screened prospect.

6. The method of 4, wherein:
the strength is based at least in part on a type of interaction between prospects; and
the further screening is based at least in part on the strength of at least one connection between an additional prospect and a screened prospect.

7. The method of claim 3, further comprising tracking purchasing behavior of prospects who have redeemed the promotional offer to determine a success criterion associated with each such prospect, the screening being based at least in part on the success criteria.

8. The method of claim 3, further comprising screening the additional prospects based on past purchasing behavior from the merchant.

9. The method of claim 3, further comprising screening the additional prospects based on past purchasing behavior at locations geographically proximate to the merchant.

10. The method of claim 3, further comprising screening the additional prospects based on past purchasing behavior of goods or services related to the goods or services that are the subject of the promotional offer.

11. A system for conducting a marketing campaign to identify consumers for a promotional offer for goods or services offered by a merchant, the system comprising:
(a) a prospect database for storing information regarding a plurality of consumers; and
(b) a processor for executing:
(i) a first identification module for identifying, from among the consumers in the prospect database, a seed prospect likely to redeem the promotional offer and subsequently purchase goods or services from the merchant;
(ii) a query module for obtaining, from at least one social media website, information regarding social connections of the at least one seed prospect;
(iii) a second identification module for identifying, based on computational analysis of the social-connection information, additional prospects also likely to redeem the promotional offer and subsequently purchase goods or services from the merchant;
(iv) a screening module for (A) accessing stored data indicative of past transactions of the additional prospects and (B) screening the additional prospects based on at least one of (i) a history of their past purchases or (ii) their past purchases in response to promotional campaigns; and
(iv) a distribution module, responsive to the screening module, for transmitting the promotional offer to the seed prospect and the screened additional prospects.

12. The system of claim 11, wherein the screening module is further configured to screen the additional prospects based on information obtained by the query module and relevant to a receptivity to the promotional offer.

13. The system of claim 12, wherein the screening module is further configured to further screen based in part on a strength of the social connection information among prospects.

14. The system of claim 13, wherein:
the strength is based at least in part on a number of interactions between prospects; and
the further screening is based at least in part on the strength of at least one connection between an additional prospect and a screened prospect.

15. The system of claim 13, wherein:
the strength is based at least in part on a type of interaction between prospects; and
the further screening is based at least in part on the strength of at least one connection between an additional prospect and a screened prospect.

16. The system of claim 12, further comprising a tracking module for tracking purchasing behavior of prospects who have redeemed the promotional offer to determine a success criterion associated with each such prospect, the screening being based at least in part on the success criteria.

17. The system of claim 12, wherein the prospect database stores past purchasing behavior of prospects from the merchant, the screening module being configured to screen the additional prospects based thereon.

18. The system of claim 12, wherein the prospect database stores past purchasing behavior of prospects from locations geographically proximate to the merchant, the screening module being configured to screen the additional prospects based thereon.

19. The system of claim 12, wherein the prospect database stores past purchasing behavior of prospects based on types of goods and services, the screening module being configured to screen the additional prospects based on past purchasing behavior of goods or services related to the goods or services that are the subject of the promotional offer.

20. The method of claim 1, further comprising the step of downwardly weighting additional prospects who have claimed a promotional offer in the past but did not spend additional money or become repeat customers with the merchant offering the promotion.

21. The method of claim 1, further comprising according a weight to at least some of the additional prospects based on data indicative of brand loyalty.

22. The system of claim 11, wherein the screening module is further configured to downwardly weight additional prospects who have claimed a promotional offer in the past but did not spend additional money or become repeat customers with the merchant offering the promotion.

23. The system of claim 11, wherein the screening module is further configured to accord a weight to at least some of the additional prospects based on data indicative of brand loyalty.
